(19) United States
(12) Patent Application Publication
(10) Pub. No.: US 2010/0029365 A1
(43) Pub. Date: Feb. 4, 2010

(54) GAMING SYSTEM AND A METHOD OF GAMING

(75) Inventor: George Roukis, Miranda (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, Lane Cove (AU)

(21) Appl. No.: 12/196,752

(22) Filed: Aug. 22, 2008

(30) Foreign Application Priority Data
Aug. 23, 2007 (AU) 2007904571

(51) Int. Cl. A63F 9/24; A63F 13/00

(52) U.S. Cl. 463/20; 463/30

(57) ABSTRACT

A method of gaming comprising: (a) conducting a game round in which a a plurality of symbols are selected; (b) determining a current number of available game rounds based at least on whether or not the selected symbols include at least one designated symbol subsequent to the symbol selection of the game round; and (c) repeating steps (a) and (b) until an end condition is met, wherein there are one or more end conditions and at least one end condition is that the current number of available game rounds is determined to be an end value.

### CROSS-REFERENCE TO RELATED APPLICATIONS

The present application claims the benefit of priority to Australian Provisional Patent Application No. 2007904571, filed on Aug. 23, 2007, entitled “A Gaming System and a Method of Gaming”, which is herein incorporated by reference in their entirety.

### FIELD

The present invention relates to a gaming system, a method of gaming, a game controller and computer program code.

### BACKGROUND TO THE INVENTION

It is known to provide a gaming system which has a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a video display.

While such gaming systems provide users with enjoyment, a need exists for alternative gaming systems in order to maintain or increase player enjoyment.

### SUMMARY OF THE INVENTION

In a first aspect, the invention provides a method of gaming including:
(a) conducting a game round in which a plurality of symbols are selected;
(b) determining a current number of available game rounds based at least on whether or not the selected symbols include at least one designated symbol subsequent to the symbol selection of the game round; and
(c) repeating steps (a) and (b) until an end condition is met, wherein there are one or more end conditions and at least one end condition is that the current number of available game rounds is determined to be an end value.

In an embodiment, the end value is zero.

In an embodiment, the method includes reducing the number of available game rounds by one if the selected symbols of a game round include no designated symbols.

In an embodiment, the method includes awarding an entitlement to an initial number of available game rounds.

In an embodiment, the initial number is three.

In an embodiment, determining the current number of available game rounds includes setting the current number to the initial number if the selected symbols include at least one designated symbol.

In an embodiment, determining the current number of available game rounds includes not altering the number of available game rounds if the selected symbols include at least one designated symbol.

In an embodiment, determining the current number of available game rounds includes reducing the number of available game rounds by a first value if the selected symbols include at least one designated symbol, and reducing the number of available game rounds by a second value greater than the first value if the selected symbols do not include any designated symbols.

In an embodiment, there are at least two end conditions, and an end condition is that a designated number of designated symbols is reached.

In an embodiment, there are two end conditions.

In an embodiment, the method includes awarding a prize determined at least in part by the number of designated symbols when an end condition is met.

In an embodiment, the method includes awarding a prize determined at least in part by a pattern of designated symbols when an end condition is met.

In an embodiment, the method includes retaining at least one designated symbol for at least one subsequent game round.

In an embodiment, the method includes retaining each designated symbol for at least one subsequent game round.

In an embodiment, the method includes retaining each designated symbol until an end condition is met.

In an embodiment, the method includes removing at least one designated symbol if a removal condition is met.

In a second aspect the invention provides a game controller for a gaming system, the game controller arranged to:
(a) conduct a game round in which a plurality of symbols are selected;
(b) determine a current number of available game rounds based at least on whether or not the selected symbols include at least one designated symbol subsequent to the symbol selection of the game round; and
(c) repeat (a) and (b) until an end condition is met, wherein there are one or more end conditions and at least one end condition is that the current number of available game rounds is determined to be an end value.

In an embodiment, the game controller includes an available game round module arranged to determine the current number of available game rounds.

In an embodiment, the game controller includes an end condition module arranged to determine that an end condition is met.

In an embodiment, the end value is zero.

In an embodiment, the game controller is arranged to reduce the number of available game rounds by one if the selected symbols of a game round include no designated symbols.

In an embodiment the game controller includes an entitlement module arranged to award an entitlement to an initial number of available game rounds.

In an embodiment, the initial number is three.

In an embodiment, the game controller is arranged to determine the current number of available game rounds by setting the current number to the initial number if the selected symbols include at least one designated symbol.

In an embodiment, the game controller is arranged to determine the current number of available game rounds by not altering the number of available game rounds if the selected symbols include at least one designated symbol.

In an embodiment, the game controller is arranged to determine the current number of available game rounds by reducing the number of available game rounds by a first value if the selected symbols include at least one designated symbol, and reducing the number of available game rounds by a second value greater than the first value if the selected symbols do not include any designated symbols.

In an embodiment, there are at least two end conditions, and an end condition is that a designated number of designated symbols is reached.

In an embodiment, there are two end conditions.

In an embodiment, the game controller includes an outcome determiner arranged to determine whether to award a prize when an end condition is met.

In an embodiment, the outcome determiner is arranged to determine any award based on the number of designated symbols when an end condition is met.

In an embodiment, the outcome determiner is arranged to determine any award based on a pattern of designated symbols when an end condition is met.

In an embodiment, the game controller is arranged to retain at least one designated symbol for at least one subsequent game round.

In an embodiment, the game controller is arranged to retain each designated symbol for at least one subsequent game round.

In an embodiment, the game controller is arranged to retain each designated symbol until an end condition is met.

In an embodiment, the game controller is arranged to remove at least one designated symbol if a removal condition is met.

In an embodiment, the game controller is constituted, at least in part, by a processor executing program code stored in a memory.

In a third aspect the invention provides a gaming system including:
a player interface including a display for displaying game outcomes; and
a game controller arranged to:
(a) conduct a game round in which a plurality of symbols are selected;
(b) determine a current number of available game rounds based at least on whether or not the selected symbols include at least one designated symbol subsequent to the symbol selection of the game round; and
(c) repeat (a) and (b) until an end condition is met, wherein there are one or more end conditions and at least one end condition is that the current number of available game rounds is determined to be an end value.

In an embodiment, the game controller includes an available game round module arranged to determine the current number of available game rounds.

In an embodiment, the game controller includes an end condition module arranged to determine that an end condition is met.

In an embodiment, the end value is zero.

In an embodiment, the game controller is arranged to reduce the number of available game rounds by one if the selected symbols of a game round include no designated symbols.

In an embodiment, the game controller includes an entitlement module arranged to award an entitlement to an initial number of available game rounds.

In an embodiment, the initial number is three.

In an embodiment, the game controller is arranged to determine the current number of available game rounds by setting the current number to the initial number if the selected symbols include at least one designated symbol.

In an embodiment, the game controller is arranged to determine the current number of available game rounds by not altering the number of available game rounds if the selected symbols include at least one designated symbol.

In an embodiment, the game controller is arranged to determine the current number of available game rounds by reducing the number of available game rounds by a first value if the selected symbols include at least one designated symbol, and reducing the number of available game rounds by a second value greater than the first value if the selected symbols do not include any designated symbols.

In an embodiment, there are at least two end conditions, and an end condition is that a designated number of designated symbols is reached.

In an embodiment, there are two end conditions.

In an embodiment, the game controller includes an outcome determiner arranged to determine whether to award a prize when an end condition is met.

In an embodiment, the outcome determiner is arranged to determine any award based on the number of designated symbols when an end condition is met.

In an embodiment, the outcome determiner is arranged to determine any award based on a pattern of designated symbols when an end condition is met.

In an embodiment, the game controller is arranged to retain at least one designated symbol for at least one subsequent game round.

In an embodiment, the gaming system is arranged to retain each designated symbol for at least one subsequent game round.

In an embodiment, the gaming system is arranged to retain each designated symbol until an end condition is met.

In an embodiment, the game controller is arranged to remove at least one designated symbol if a removal condition is met.

In a fourth aspect the invention provides computer program code which when executed implements the above method.

In a fifth aspect the invention provides a computer readable medium including the above program code.

In a sixth aspect the invention provides a data signal including the program code.

In a seventh aspect the invention extends to transmitting the program code.

### BRIEF DESCRIPTION OF THE DRAWINGS

Certain embodiments of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a diagram schematic of a networked gaming system;

FIG. 6 is a further block diagram of the gaming system;

FIG. 7 is a flow chart of an embodiment; and

FIGS. 8A and 8B are exemplary game outcomes.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

The embodiment provides a gaming system where a player obtains an entitlement to an initial number of available game rounds. Each game round, symbols are selected. The current number of game rounds is adjusted based on whether the selected symbols include a designated symbol until an end condition is met. One end condition is that the current number of game rounds reaches a designated value—e.g. zero. The gaming system may be provided in a number of different forms.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

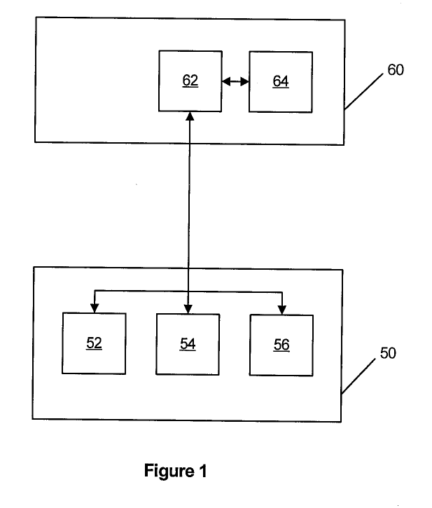

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

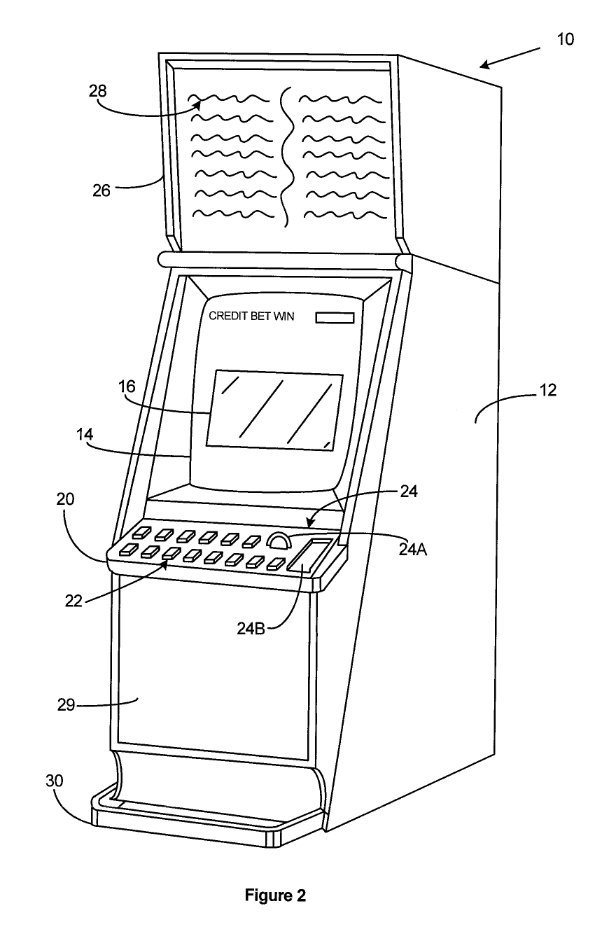

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module may be provided having a reading device for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

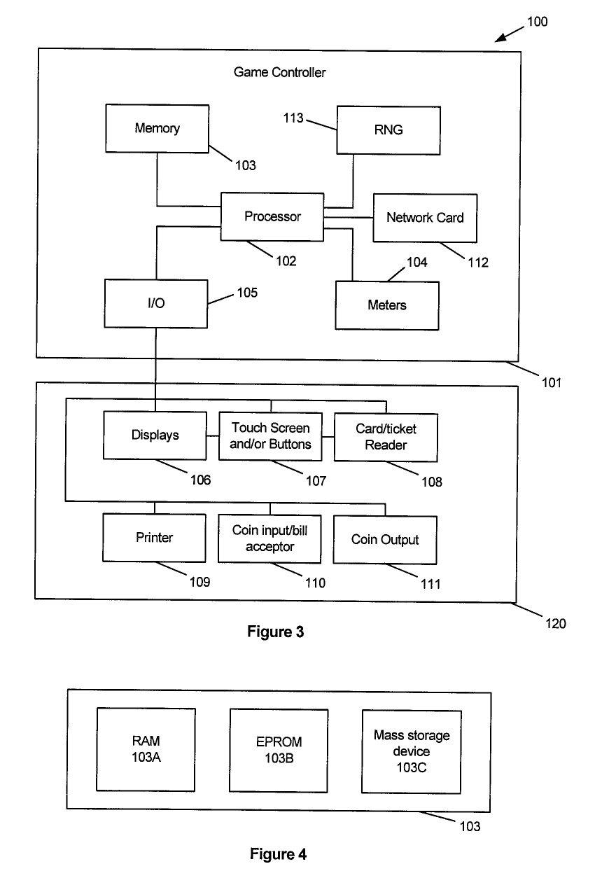

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen 107, a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

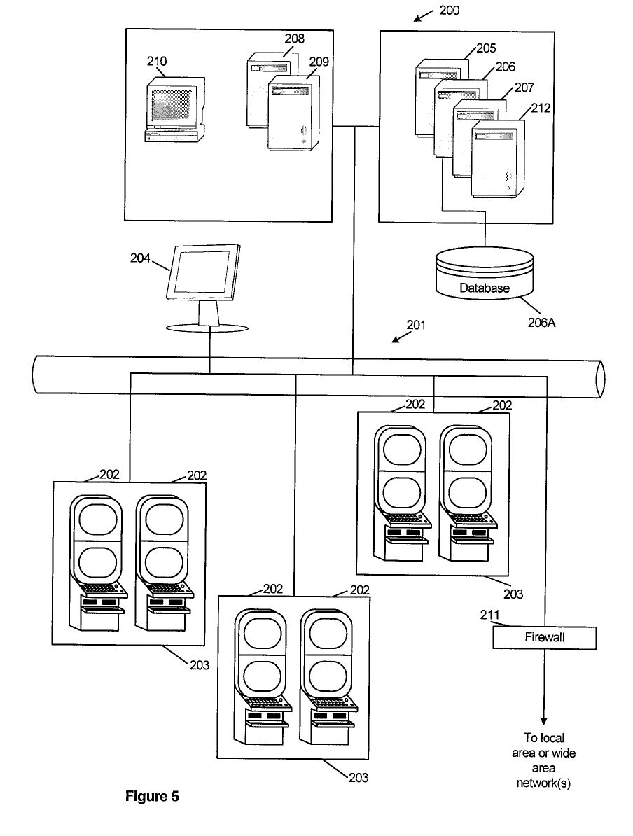

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106, 107, 108, 109, 110, 111 to be provided remotely from the game controller 101.

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10, 100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games depending upon the involved terminals.

Gaming systems for implementing games that involve a display of spinning reels as part of the display of the outcome of a game have either a video display or a mechanical display, these later machines most usually being “stepper” machines which have a separate motor for each reel.

In some implementations the game controllers of such gaming machines select symbols by employing a stop determining function that randomly determines the stop position for each reel. For example, if there are five reels, each having twenty symbols, the stop determining function might determine that the stop positions are positions: 3, 13, 7, 9 and 17. The spinning of the reels is then controlled so that each symbol comes to a stop in the same row, typically a predetermined row in a “window” visible to the player on the display that which corresponds to a player playing a single win line. When a reel stops, the symbols will be in one of a plurality of possible symbol positions for that reel relative to the stop position which constitutes a game outcome.

Embodiments of the present invention relate to gaming systems that allow a player to select how many win lines of a plurality of win lines they will play in each game—i.e. a minimum of one win line up to the maximum number of win lines allowed by the game. Each win line is formed by a set of symbol positions consisting of one symbol position from each reel. That is, a predetermined symbol position of each reel is assigned to a win line. The symbol positions that constitute each of the win lines are usually advertised to the player by markings on the display or diagrams showing the symbol positions that correspond to each win line. However, other techniques are known for establishing the basis on which symbols are evaluated. One technique is found in so-called Reel Power games, where a player selects a number of reels to be played and combinations of symbol positions in the display window are evaluated based on the selected reels. The selection of a reel means that each symbol of the reel can be substituted for a symbol at one or more designated display positions. In other words, all symbol positions of a selected reel can be used to form symbol combinations with designated, displayed symbol positions of other reels.

In other embodiments a player win entitlement may be affected by purchasing access to particular pay tables—e.g. a first bet amount entitles the player to wins including cherries and a second amount entitles them to wins including plums.

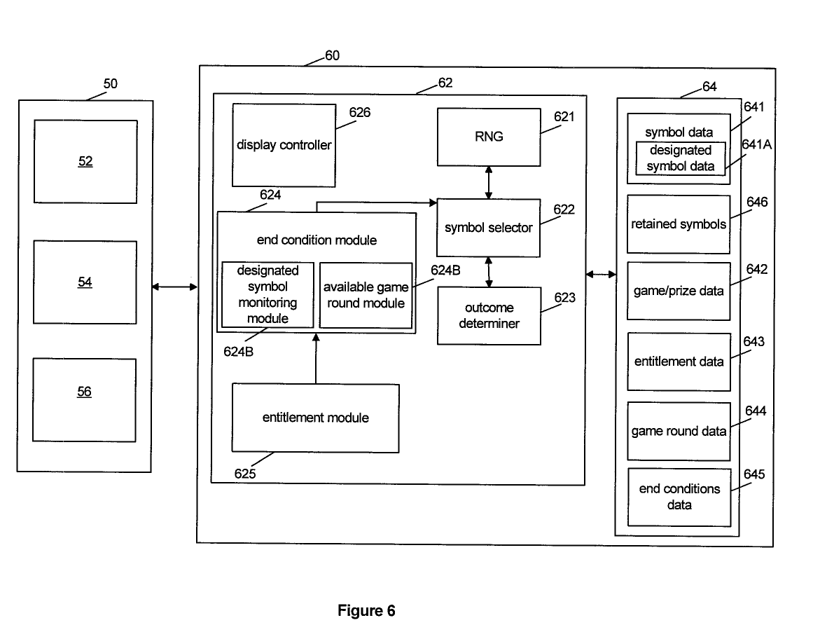

The game controller 60 of the embodiment is shown in more detail in FIG. 6. In FIG. 6 a number of modules are implemented by the processor 62 including random number generator 621, symbol selector 622, outcome determiner 623, end condition module 624, entitlement module 625 and display controller 626. In this embodiment, the modules are implemented as software stored in memory 64 and executed by the processor. Persons skilled in the art will appreciate that in other embodiments, one or more of the modules may be implemented on a different processor. For example, the random number generator may be implemented on a random number generator server. Further, not all of the modules need be implemented as software executed by a processor and could use dedicated hardware.

In FIG. 6, an entitlement module 625 determines whether a player is entitled to participate in the game in accordance with known rules.

In the embodiment, the game is implemented as a feature game which is triggered during play of a game. However, the game need not be implemented as a feature game. The player's eligibility for the feature game can be determined in accordance with any one of a number of known rules including but not limited to:
being available at the player's discretion;
being available to all players for all bets;
being available in free games;
being available only for certain bet types; or
different numbers of game rounds being available.

The feature game can commence in accordance with any one of a number of known triggering rules including but not limited to:
when a special symbol, or a combination of symbols appears in the window;
when a time elapses;
when a system event occurs;
when an underlying random event occurs, for example, in the course of a game;
when a turnover has elapsed.

Once the feature game commences, an end condition module 624 monitors the number of game rounds based on game round data 644 and end condition data 645. The game round data 644 specifies an initial number of game rounds that are available to the player.

The end condition module controls the symbol selector 622 to select a first set of symbols from symbol data 641 which includes designated symbols 641a. Symbol data 641 will typically specify a set of available symbols for each of a plurality of reels. The symbol selector 622 selects the symbols by employing random number generator in accordance with any one of several known techniques. The end condition module 624 determines after the symbol selector has selected the symbols whether an end condition has been met. In the embodiment, the end conditions are that the available number of game rounds has been exhausted or that a maximum number of designated symbols have been obtained. Accordingly, it is unlikely in the first round that either of these conditions is met.

To monitor these two end conditions, the end condition module 624 includes a designated symbol monitoring module 624a which monitors the current number of designated symbols and an available game round module 624b which monitors the current number of game rounds. The available game round module 624b determines after each set of symbols are selected whether to adjust the number of game rounds and stores a current game round value in the game round data 644. This current game round value is used in determining the subsequent current game round value.

In the embodiment if a designated symbol is included in the selected symbols, the available game round module 624b sets a counter representing the available number of game rounds to the initial value. If the selected symbol does not include a designated symbol, the counter is reduced by one. The process continues until an end condition is met, for example, the counter reaching a designated end value such as zero.

Persons skilled in the art will appreciate that a number of variations may be used to control the available number of game rounds. For example, in one embodiment, rather than resetting the current value, the current value may be retained. In a further embodiment, the current value may be decremented by a first amount if a designated symbol is selected and a second amount greater than the first amount if a designated symbol is not selected. In any event, in the embodiment, after each round, the game round data is updated to reflect the current number of available game rounds.

In the embodiment, once a designated symbol is selected, it is retained in subsequent game rounds. The retained symbols are stored as retained symbol data 646 in memory 64. These retained symbols are removed from the pool of available symbols 641 to select. Further, they are displayed by a display controller in the same display position on display 54 and new symbols are not selected for these display positions by the symbol selector 622 in subsequent game rounds. Alternatively, symbols are selected but they are not displayed or are displayed with the retained symbols superpose.

As indicated above, the game continues until an end condition is met. Once an end condition is met, the outcome determiner 623 determines a prize based on the designated symbols which are retained at the time the end condition is met as stored in game round data 644. Depending on the embodiment, the outcome may be determined in accordance with game/prize data 642 based on a number of symbols, a pattern or symbols or a combination of symbols.

Further, the outcome determiner 623 may additionally be arranged to determine a game outcome at the conclusion of each game round based on the currently displayed symbols by evaluating win lines or the like in a conventional manner, for example, with the designated symbols acting as wild symbols.

In the embodiment, to ensure player return is constant for variable bets, the probability of the occurrence of designated symbols is varied to match the bets. Alternatively, the prize can be varied to match the bets or a combination of both or alternatively the probability of triggering the game can be changed.

In an alternative embodiment, when a certain number of special symbols or pattern of special symbols occurs, those symbols are removed from the playing space. Depending on the embodiment, removed symbols can be counted and used in the final overall valuation of the prize or may not be counted. Where symbols are removed, this will provide additional spaces for symbols to be added.

Depending on the embodiment, some designated symbols can have a greater value than other designated symbols. For example, designated symbols of one reel can have a greater value. Further, retained designated symbols need not be retained in their original position and could, for example, move to different display positions. For example, they may fill the display positions in a random manner or in accordance with a fill pattern.

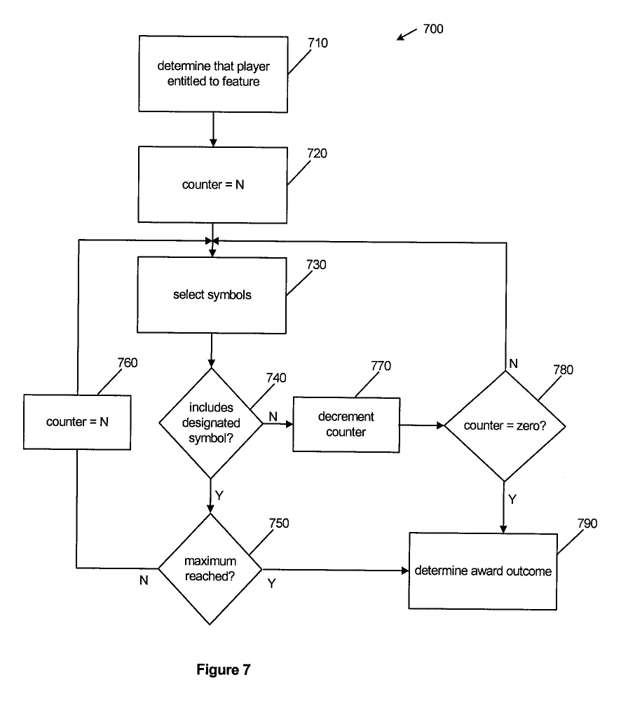

The process 700 of the embodiment is summarised in FIG. 7. The process begins by determining whether a player is entitled to the feature 710. The counter is set 720 to N, the initial number of available game rounds. A set of symbols is selected 730 and at step 740 it is determined whether these include a designated symbol. If they include a designated symbol, it is determined at step 750 whether a maximum number of symbols has been reached. If the answer is yes, an award outcome is determined at step 790. If the answer is no at step 750, then the counter is reset to N at step 760. The process then continues by selecting further symbols. If the answer at step 740 is that there is no designated symbol then the counter is decreased 770 and is determined at step 780 whether the counter equals to zero. If the counter does not equal to zero then a further set of symbols is selected 730. Alternatively, when the counter reaches zero an award outcome is determined 790.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server).

### Example

A player is eligible to play a feature.

The screen changes to show new reels strips.

A meter is shown to indicate that 3 spins are available.

The reels spin and if a gold pan symbol appears on the reels, the gold pan symbol remains on the reels. (sticky wild). The number of spins remaining stays at 3.

If no gold pan symbol occurs, the meter decrements by 1 to show that only 2 spins remain.

The reels spin again and any gold pans remain in position.

Any new gold pans will be hold for further spins.

If new gold pan/s are acquired, the meter is reset to 3.

If no new gold pans are acquired, the meter decrements by 1.

This process continues until there are no spins left on the meter or the screen is filled with pans,

The total number of gold pans is then calculated.

This number is compared to a prize schedule and a prize awarded.

If a pattern of gold pans is being held, a bonus prize could be awarded. For example, if a row of gold pans is collected, a bonus prize could be awarded in addition to the prize determined by the total count.

If a pattern of gold pans is being held, the count for the pans could be recorded in a count meter and then the pans disappear from the screen. (i.e., the pans are being “cashed in early”) so that there are additional chances of getting pans.

In this example, the machines determines how many pans to stop of the reels by consulting a probability table related to turnover or bet placed at the time the feature was triggered.

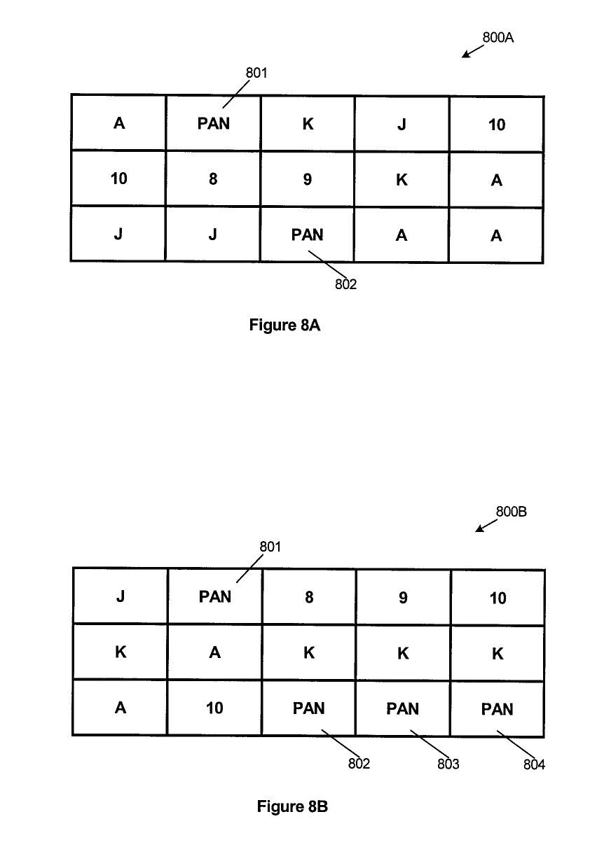

FIGS. 8a and 8b show exemplary game outcomes 800a, 800b respectively, corresponding to this embodiment. After an initial spin, two gold pans represented by the words PAN 801, 802 appear on the display. A counter remains at three. In FIG. 8b, the reels spin again and pans 801 and 802 are retained. In this game round, two further pans 803, 804 appear on the reels. A series of further game rounds are carried out but no further pans are revealed. Accordingly, the prize is determined based on the fact that there are four pans. In an alternative embodiment, three pans 802, 803, 804 may pay an additional prize for being a pattern. Alternatively, only pans 802, 803 and 804 may pay a prize, if the sole determining factor of awarding a prize is a pattern of pans. Further, additional prizes may be paid. For example, in FIG. 8a, if prizes pay left to right and pan acts as a wild symbol, then a prize may be paid for the pattern J, J, PAN.

Other variations will be apparent to a person skilled in the art and should be understood as falling within the scope of the invention described herein. For example, the symbol selection game could be a card game or a ball draw game such as keno, bingo or arishinko.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. As noted above, certain embodiments of the present invention may be implemented using an existing computer processor and/or by a special purpose computer processor incorporated for this or another purpose or by a hardwired system, for example.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A method of gaming comprising:
(a) conducting a game round in which a plurality of symbols are selected;
(b) determining a current number of available game rounds based at least on whether or not the selected symbols include at least one designated symbol subsequent to the symbol selection of the game round; and
(c) repeating steps (a) and (b) until an end condition is met, wherein there are one or more end conditions and at least one end condition is that the current number of available game rounds is determined to be an end value.

2. A method as claimed in claim 1, wherein the end value is zero.

3. A method as claimed in claim 1 or claim 2, comprising reducing the number of available game rounds by one if the selected symbols of a game round include no designated symbols.

4. A method as claimed in any one of claims 1 to 3 comprising awarding an entitlement to an initial number of available game rounds.

5. A method as claimed in claim 4, wherein the initial number is three.

6. A method as claimed in claim 4, wherein determining the current number of available game rounds comprises setting the current number to the initial number if the selected symbols include at least one designated symbol.

7. A method as claimed in claim 1, wherein determining the current number of available game rounds comprises not altering the number of available game rounds if the selected symbols include at least one designated symbol.

8. A method as claimed in claim 1, wherein determining the current number of available game rounds comprises reducing the number of available game rounds by a first value if the selected symbols include at least one designated symbol, and reducing the number of available game rounds by a second value greater than the first value if the selected symbols do not include any designated symbols.

9. A method as claimed in claim 1, wherein there are at least two end conditions, and an end condition is that a designated number of designated symbols is reached.

10. A method as claimed in claim 8 wherein there are two end conditions.

11. A method as claimed in claim 1, comprising awarding a prize determined at least in part by the number of designated symbols when an end condition is met.

12. A method as claimed in claim 1, comprising awarding a prize determined at least in part by a pattern of designated symbols when an end condition is met.

13. A method as claimed in claim 1, comprising retaining at least one designated symbol for at least one subsequent game round.

14. A method as claimed in claim 13, comprising retaining each designated symbol for at least one subsequent game round.

15. A method as claimed in claim 13, comprising retaining each designated symbol until an end condition is met.

16. A method as claimed in claim 13 comprising removing at least one designated symbol if a removal condition is met.

17. A game controller for a gaming system, the game controller arranged to:
(a) conduct a game round in which a plurality of symbols are selected;
(b) determine a current number of available game rounds based at least on whether or not the selected symbols include at least one designated symbol subsequent to the symbol selection of the game round; and
(c) repeat (a) and (b) until an end condition is met, wherein there are one or more end conditions and at least one end condition is that the current number of available game rounds is determined to be an end value.

18. A game controller as claimed in claim 17, comprising an available game round module arranged to determine the current number of available game rounds.

19. A game controller as claimed in claim 17, comprising an end condition module arranged to determine that an end condition is met.

20. A game controller as claimed in claimed in claim 17, wherein the end value is zero.

21. A game controller as claimed in claimed in claim 17, the game controller arranged to reduce the number of available game rounds by one if the selected symbols of a game round include no designated symbols.

22. A game controller as claimed in any one of claims 17, comprising an entitlement module arranged to award an entitlement to an initial number of available game rounds.

23. A game controller as claimed in claim 22, wherein the initial number is three.

24. A game controller as claimed in claim 22, the game controller arranged to determine the current number of available game rounds by setting the current number to the initial number if the selected symbols include at least one designated symbol.

25. A game controller as claimed in claim 22, the game controller arranged to determine the current number of available game rounds by not altering the number of available game rounds if the selected symbols include at least one designated symbol.

26. A game controller as claimed in claim 22, the game controller arranged to determine the current number of available game rounds by reducing the number of available game rounds by a first value if the selected symbols include at least one designated symbol, and reducing the number of available game rounds by a second value greater than the first value if the selected symbols do not include any designated symbols.

27. A game controller as claimed in claim 17, wherein there are at least two end conditions, and an end condition is that a designated number of designated symbols is reached.

28. A game controller as claimed in claim 27, wherein there are two end conditions.

29. A game controller as claimed in claim 17, comprising an outcome determiner arranged to determine whether to award a prize when an end condition is met.

30. A game controller as claimed in claim 29, wherein the outcome determiner is arranged to determine any award based on the number of designated symbols when an end condition is met.

31. A game controller as claimed in claim 29, wherein the outcome determiner is arranged to determine any award based on a pattern of designated symbols when an end condition is met.

32. A game controller as claimed in claim 17, arranged to retain at least one designated symbol for at least one subsequent game round.

33. A game controller as claimed in claim 32, arranged to retain each designated symbol for at least one subsequent game round.

34. A game controller as claimed in claim 32, arranged to retain each designated symbol until an end condition is met.

35. A game controller as claimed in claim 33 arranged to remove at least one designated symbol if a removal condition is met.

36. A game controller as claimed in claim 17, constituted, at least in part, by a processor executing program code stored in a memory.

37. A gaming system comprising:
a player interface comprising a display for displaying game outcomes; and
a game controller arranged to:
(a) conduct a game round in which a plurality of symbols are selected;
(b) determine a current number of available game rounds based at least on whether or not the selected symbols include at least one designated symbol subsequent to the symbol selection of the game round; and
(c) repeat (a) and (b) until an end condition is met, wherein there are one or more end conditions and at least one end condition is that the current number of available game rounds is determined to be an end value.

38. A gaming system as claimed in claim 37, wherein the game controller comprises an available game round module arranged to determine the current number of available game rounds.

39. A gaming system as claimed in claim 37, wherein the game controller comprises an end condition module arranged to determine that an end condition is met.

40. A gaming system as claimed in claimed in claim 37, wherein the end value is zero.

41. A gaming system as claimed in claimed in claim 37, wherein the game controller is arranged to reduce the number of available game rounds by one if the selected symbols of a game round include no designated symbols.

42. A gaming system as claimed in claim 37, wherein the game controller comprises an entitlement module arranged to award an entitlement to an initial number of available game rounds.

43. A gaming system as claimed in claim 42, wherein the initial number is three.

44. A gaming system as claimed in claim 42, wherein the game controller is arranged to determine the current number of available game rounds by setting the current number to the initial number if the selected symbols include at least one designated symbol.

45. A gaming system as claimed in claim 42, wherein the game controller is arranged to determine the current number of available game rounds by not altering the number of available game rounds if the selected symbols include at least one designated symbol.

46. A gaming system as claimed in claim 42, wherein the game controller is arranged to determine the current number of available game rounds by reducing the number of available game rounds by a first value if the selected symbols include at least one designated symbol, and reducing the number of available game rounds by a second value greater than the first value if the selected symbols do not include any designated symbols.

47. A gaming system as claimed in claim 37, wherein there are at least two end conditions, and an end condition is that a designated number of designated symbols is reached.

48. A gaming system as claimed in claim 37, wherein there are two end conditions.

49. A gaming system as claimed in claim 37, wherein the game controller comprises an outcome determiner arranged to determine whether to award a prize when an end condition is met.

50. A gaming system as claimed in claim 49, wherein the outcome determiner is arranged to determine any award based on the number of designated symbols when an end condition is met.

51. A gaming system as claimed in claim 49, wherein the outcome determiner is arranged to determine any award based on a pattern of designated symbols when an end condition is met.

52. A gaming system as claimed in claim 37, wherein the game controller is arranged to retain at least one designated symbol for at least one subsequent game round.

53. A gaming system as claimed in claim 52, arranged to retain each designated symbol for at least one subsequent game round.

54. A gaming system as claimed in claim 52, arranged to retain each designated symbol until an end condition is met.

55. A gaming system as claimed in claim 33, wherein the game controller is arranged to remove at least one designated symbol if a removal condition is met.

56. A computer readable medium including computer program code which when executed implements the method of claim 1.
